(19) United States
(12) Patent Application Publication
(10) Pub. No.: US 2021/0333876 A1
(43) Pub. Date: Oct. 28, 2021

(54) SYSTEM AND METHOD FOR INTERACTING WITH DEVICES USING A PERSON'S FINGERS

(71) Applicant: HISEP TECHNOLOGY LTD., YAVNE (IL)

(72) Inventors: YARIV ERAD, KIDRON (IL); GAD VERED, BE'ER YA'AKOV (IL); URI VERED, RISHON LEZION (IL); MENACHEM ERAD, ASHDOD (IL)

(21) Appl. No.: 17/241,158

(22) Filed: Apr. 27, 2021

Related U.S. Application Data
(60) Provisional application No. 63/015,700, filed on Apr. 27, 2020.

(51) Int. Cl. G06F 3/01; G06F 3/042; H04N 5/38

(52) U.S. Cl. CPC G06F 3/014; H04N 5/38; G06F 3/0425

(57) ABSTRACT

A system including an electronic device and a sleeve configured to be worn on a person's finger, the sleeve including a body, having a size matching a person's finger and electrical circuitry coupled to the body, the circuitry including one or more sensors for collecting information, a processing device for processing the collected information, and a transceiver for sending information to the electronic device.

### FIELD

The disclosure generally relates to interacting with devices using a person's fingers.

### BACKGROUND

When holding a smart phone device in a hand in order to operate or look at its screen, one can see that two fingers of the holding hand remain with a lot of “freedom” to move, rotate and flex in various directions while holding the device.

A user sometimes uses these fingers to operate the smart-phone—either buttons on the sides of the device or by pressing the display (touch screen display and/or keyboard). In many cases, the thumb and/or forefinger are not used for the operation of the smartphone and just remain idle, or even stretched by the user sideways so they will not disturb him from looking at the device's display or using the fingers of his other hand to operate the device's display.

In addition, device manufacturers and designers are trying to embed more and more technologies inside the smartphone, especially RF-based technologies. For example, the number of applied RF frequencies is growing, including 5G frequencies and UWB frequencies. Device manufacturers also try to integrate antenna arrays inside the smart-phone, to enable directional capabilities. For example, Apple has integrated 4 UWB dedicated antennas into its line of iPhone 11 smart-phones, in what seems like a design of an antenna array that might be used in the future to enable UWB-based DF and/or Distance measurement.

Yet, it is clear to a person skilled in the art that integration of a growing RF components and antennas in such tight, close-proximity form-factor may result in mutual interferences between the component, that in turn may cause less than optimal operation, up to total failure.

### SUMMARY

The subject matter discloses a sleeve that can be used as an accessory for electronic devices (such as—but not limited to—smart phones). The sleeve is configured to be worn on a user's fingers, utilizing the unique anatomical structure of the human thumb and/or forefinger in general, and the ability of these two finger's joints to enable a wide array of movements, bending and flexibility.

The subject matter also discloses the use of direction-finding (DF) technologies and/or antennas in the sleeve to and serve as an extension to DF-related applications in the smart-phone, in such manner that said antennas serve as the DF antennas. The subject matter also discloses the integration of sensors in the sleeve.

The sleeve enables electronic device manufacturers and device's designers (such as—but not limited to—smart phones) to remove or add components from the smart-phone, as there is a growing need to integrate more and more technologies and hardware in a single device, thereby preventing potential interferences between electrical components in a single device and enabling more components to be added in a single device.

The subject matter also discloses a system including an electronic device and a sleeve configured to be worn on a person's finger, the sleeve including a body, having a size matching a person's finger and electrical circuitry coupled to the body, the circuitry including one or more sensors for collecting information, a processing device for processing the collected information, and a transceiver for sending information to the electronic device.

In some cases, the electrical circuitry is covered by fabric. In some cases, the one or more sensors include a motion sensor for collecting information concerning motion of the body. In some cases, the one or more sensors include an environmental sensor for collecting information concerning an environment of the body.

In some cases, the one or more sensors include a touch sensor for sending whether or not the sleeve is in physical contact with the remote electronic device. In some cases, the one or more sensors include a palm sensor configured to detect information enabling to determine whether the sleeve is worn by a right hand or a left hand of the person. In some cases, the system further including a light emitter directed away from the body and a light emitter input unit enabling a user of the sleeve to operate the light emitter.

In some cases, the wireless transceiver sends an azimuth of the light emitter to the remote electronic device. In some cases, the body has an elongated shape having a tip, where the light emitter is located in the tip. In some cases, the system further includes a camera directed away from the body and a camera input unit enabling a user of the sleeve to operate the camera. In some cases, the wireless transceiver sends images captured by the camera and timestamps of the images to the remote electronic device.

In some cases, the system further includes a Direction Finding (DF) unit for finding a relative direction and/or the relative distance of signals emitted in the environment of the sleeve. In some cases, the body includes two sleeves for carrying two fingers, one finger in each sleeve of the two sleeves, where each sleeve of the two sleeves includes at least one sensor. In some cases, the body is made of fabric.

The subject matter also discloses a method for creating a stream of images, including capturing a first set of images by a camera located in a sleeve worn on a person's finger, sending the images and timestamp of the images to a remote electronic device, capturing a second set of images by the remote electronic device when the first set of images are captured by the camera located in the sleeve, creating a third set of images, where images in the third set of images are assembled from the first set of images and from the second set of images.

In some cases, the method further includes sending a direction of the camera located in the sleeve when capturing the images in the first set of images, creating the third set of images based on the direction of the camera located in the sleeve when capturing the images in the first set of images.

### BRIEF DESCRIPTION OF THE DRAWINGS

The invention may be more clearly understood upon reading of the following detailed description of non-limiting exemplary embodiments thereof, with reference to the following drawings, in which:

FIGS. 1A-1D schematically show a person's fingers, partially covered by the sleeve, holding a mobile electronic device, according to exemplary embodiments of the invention;

FIG. 2 schematically shows a person's fingers, partially covered by the sleeve electrically coupled to a mobile electronic device, according to exemplary embodiments of the invention;

FIG. 3 schematically shows a sleeve having an electromagnetic absorbing material embedded therein, according to exemplary embodiments of the invention;

FIG. 4 schematically shows a sleeve and electrical components included therein, according to exemplary embodiments of the invention;

FIG. 5 schematically shows a sleeve having five sleeve portions covering all the palm's fingers, according to exemplary embodiments of the invention;

FIGS. 6A-6B schematically show a user directing a beam from a sleeve worn on the user's fingers to a remote device, according to exemplary embodiments of the invention;

FIG. 7 schematically shows a user directing at another person's forehead to measure temperature, according to exemplary embodiments of the invention;

FIGS. 8A-8B schematically show two beams emitted from a pointer in a sleeve, according to exemplary embodiments of the invention.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION

Illustrative embodiments of the invention are described below. In the interest of clarity, not all features/components of an actual implementation are necessarily described.

For the purposes of this paper, and in order to enable clear understanding of the invention described herewith, the definitions and terms used in this paper shall have the meaning set forth beside them as well as the broadest meaning resulting from their context. However, it should be clearly understood, that the use of such meanings shall in no way serve to limit the scope of possible interpretation of the ideas, and the ideas and concepts provided herewith shall apply even if other terms and definitions are used.

The examples provided in this paper relate to the use of the invention for various applications. However, it is clearly stated that the use of the invention can apply to other types of applications and devices, and for any device or application. In these cases, the features of the inventions described hereunder shall apply as well.

The term “Direction-Finding (DF)” refers to any applicable technology, method or technique—including hardware, software, Algorithms, antennas, materials—including UWB-based DF techniques—that is used to find relative direction and/or distance and/or height between at least two devices and/or objects. The DF can be based on radio waves (RF) and/or light waves and/or sound waves.

The term “Sleeve” refers to an electronic device's accessory that can be placed or worn over a human hand finger in general, and on a thumb and/or forefinger in particular—either the right or left hand. The sleeve can be made of fabric or any other material. The sleeve may be rigid or soft, may comprise smart textile and/or conductible threads. The sleeve may include absorbing materials that can absorb and/or reflect RF waves and/or light waves and/or sound waves—in whole or partially.

The Sleeve may be in the form of a thumb sleeve only. The Sleeve may be in the form of a forefinger only. The Sleeve may be in the form of a thumb and one or more forefingers together. The Sleeve may be in the form of part of a whole hand glove. The Sleeve may be in the form of a right-handed palm and/or left-handed palm, or fingers.

The term “motion sensor” may refer to an accelerometer sensor or component that measures proper acceleration—i.e., the acceleration experienced relative to freefall. Single- and multi-axis models are available to detect magnitude and direction of the acceleration as a vector quantity, and can be used to sense position, vibration and shock. The motion sensor may comprise a Gyroscope sensor or component for measuring or maintaining orientation, based on the principles of conservation of angular momentum. The motion sensor may be a tilt sensor used to measure the tilting in two axes of a reference plane in two axes, in portable electronic devices.

The term “wireless communication” shall refer to the transfer of information and/or data and/or packets (formatted blocks of data) and/or communication acknowledgment/no-acknowledgment and/or voice over long or short distances without the use of electrical conductors or “wires” but via Radio waves and/or light waves and/or sound waves, at any given frequency—such as, but not limited to—5 Khz-600 Ghz. Said wireless communication means may use any protocol or standard in any given frequency that can be used to conduct Radio and/or light and/or sound Wireless Communication, such as, but not limited to, wireless Information Technology, cellular communication (such as, but not limited to, GSM, GPRS, CDMA), Wireless Networks, WLAN computer communications, wireless networking standards (such as IEEE 802.11), wireless personal area networks (WPAN) and wireless mesh networks, and “Internet-of-Things”.

The term “Absorbing material” refers to the weakening and/or reduction in strength and/or attenuation of a wireless signal/wave—all of it or part of it—that occurs as it passes through objects and/or lossy medium and/or materials with dielectric loss properties (such as, but not limited to, the human body and/or materials with absorbing properties. Said Absorbing material may have predefined properties corresponding with the wave type and/or frequency it is aimed to absorb. “Absorbing material” may also refer to intentional delay of an electromagnetic wave and/or light wave and/or sound wave time-of-flight.

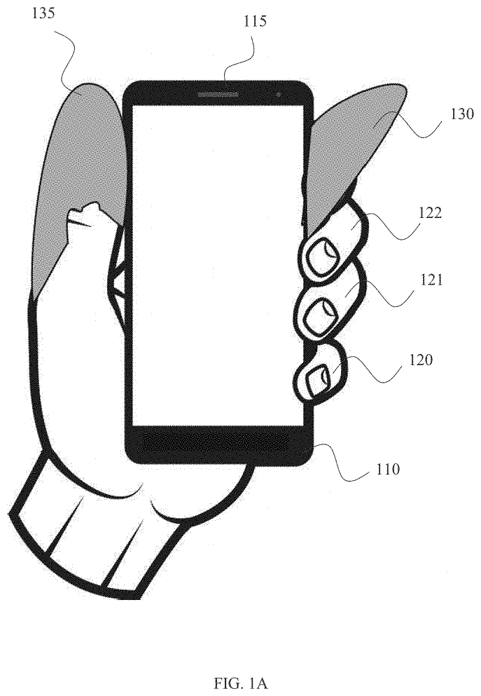

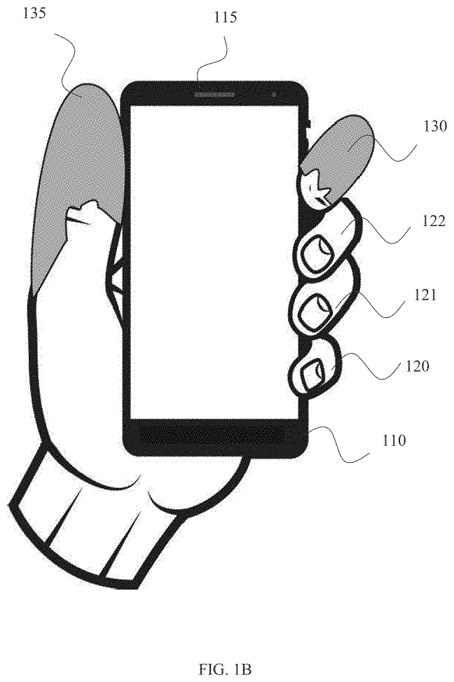

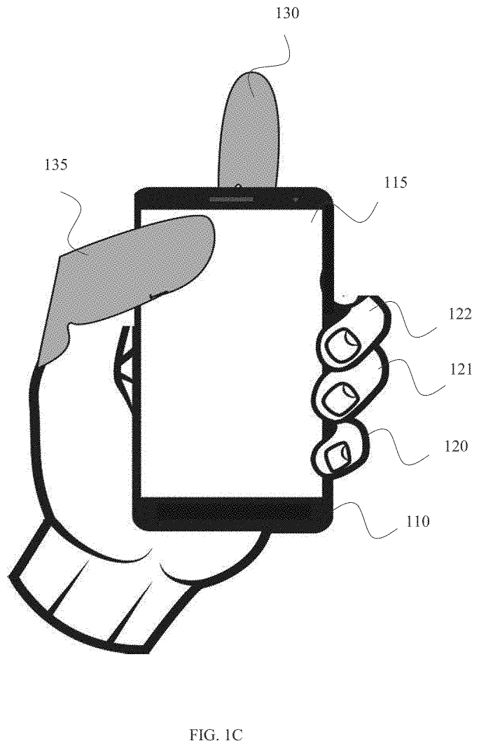

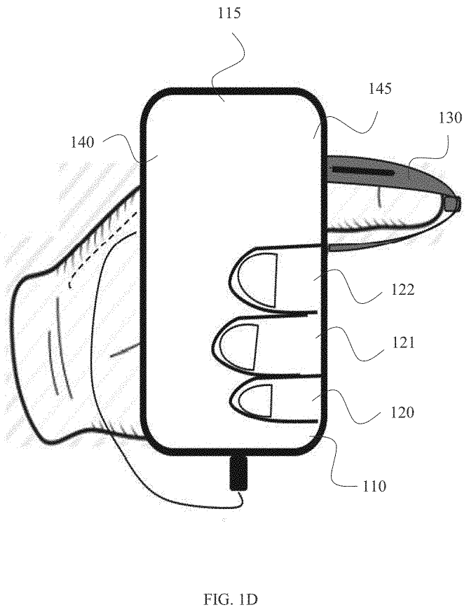

FIGS. 1A-1D schematically show a person's fingers, partially covered by the sleeve, holding a mobile electronic device, according to exemplary embodiments of the invention. The sleeve is made of a body and an electrical circuitry. The body comprises the material used to cover the user's fingers when using the sleeve. The sleeve comprises two sleeve portions 130, 135, covering the thumb and the index finger. The other fingers, namely the middle finger 122, the ring finger 121 and the baby finger 120, are not covered by the sleeve. The mobile electronic device 110 is held by the user's palm. The mobile electronic device 110 may comprise a display area 115 for displaying information.

FIG. 1A shows a free holding position, in which the middle finger 122, the ring finger 121 and the baby finger 120 touch a first side surface of the mobile electronic device 110, the thumb is in contact with a second side surface and the index finger is in the rear side of the mobile electronic device 110.

In FIG. 1B, the thumb, covered with sleeve portion 135, is placed in the second side surface of the mobile electronic device 110 while the middle finger 122, the ring finger 121 and the baby finger 120, in addition to the index finger covered by sleeve portion 130, are located in the first side surface of the mobile electronic device 110.

In FIG. 1C, the thumb, covered with sleeve portion 135, is placed in the second side surface of the mobile electronic device 110. The index finger covered by sleeve portion 130 is located in the upper side of the mobile electronic device 110 and the middle finger 122, the ring finger 121 and the baby finger 120 touch a first side surface of the mobile electronic device 110.

In FIG. 1D, the middle finger 122, the ring finger 121 and the baby finger 120 touch the display area 115 in the front side surface of the mobile electronic device 110. The thumb, covered with sleeve portion 135, is placed in the rear side of the mobile electronic device 110. The index finger covered by sleeve portion 130 laterally from the mobile electronic device 110.

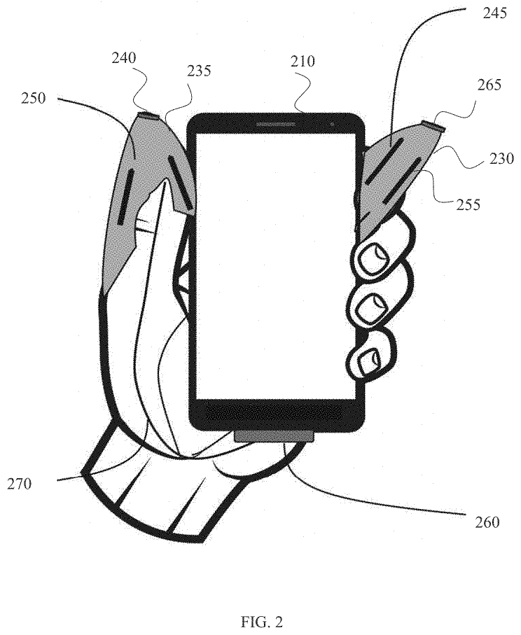

FIG. 2 schematically shows a person's fingers, partially covered by the sleeve electrically coupled to a mobile electronic device, according to exemplary embodiments of the invention. The mobile electronic device 210 is held by the user's palm, as the thumb and the index finger are covered by two sleeve portions 235 and 230, respectively. The mobile electronic device 210 comprises a connector 260 that enables coupling of a wire from a sleeve, or from a sleeve portion, such as USB coupling. The connector 260 may be coupled to multiple sleeve portions concurrently. For example, the sleeve portion 235 is coupled to a sleeve wire 270 coupled to the connector 260. The sleeve wire 270 may charge the circuitry of the sleeve portion 235, or enable the circuitry of the sleeve portion 235 to exchange information with the mobile electronic device 210.

The sleeve portion 235 may comprise an antenna 250 and a pointer 240. Similarly, the sleeve portion 230 may comprise multiple antennas 255 and 245 and a pointer 265.

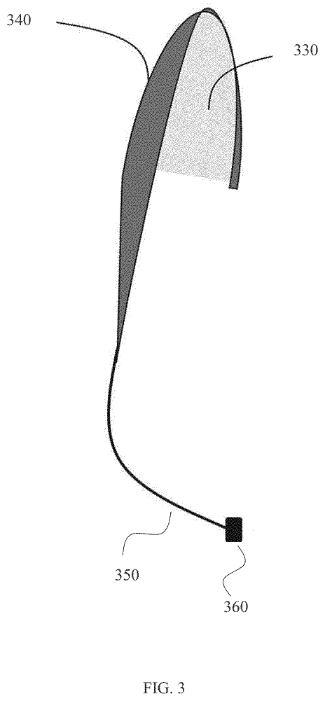

FIG. 3 schematically shows a sleeve having an electromagnetic absorbing material embedded therein, according to exemplary embodiments of the invention. The sleeve may comprise a rear cover 340 and a front cover 330. The rear cover 340 may be placed in the rear side of the finger, where the nail is. The front side 330 may comprise electromagnetic absorbing material capable or changing the propagation of an electromagnetic wave, a sound wave, or a light wave. This way, an antenna located in the sleeve may determine a relative direction of a source of the wave. The sleeve also comprises a sleeve wire 350 and a sleeve connector 360 coupled to the sleeve wire. The sleeve wire 350 is coupled to the circuitry in the sleeve, for example to a PCB controlled by a controller. The sleeve connector 360 may have a hardware or mechanical interface with a mobile electronic device, such as for example Japan Solderless Terminal (JST) connectors, screw terminals, barrel connector, molex connectors, Universal Serial Bus (USB) connectors, and the like.

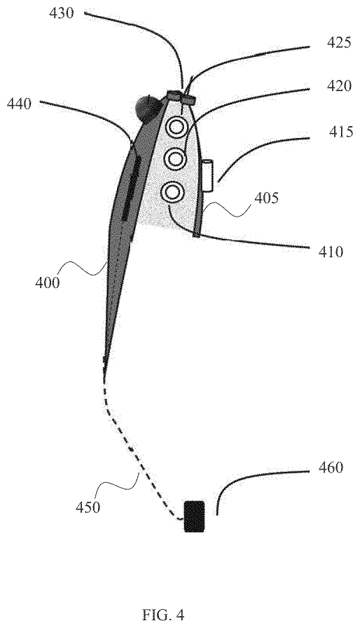

FIG. 4 schematically shows a sleeve and electrical components included therein, according to exemplary embodiments of the invention. The sleeve comprises a front cover 405 located in a front side of the finger and a rear cover 400. The sleeve shows a front pointer 415 directed towards a front side of the finger. The sleeve may also comprise a top pointer 430, directed at the top side of the finger. The front pointer 415 and the top pointer 430 may be a beam emitter, such as a laser emitter, a flashlight, emitter of non-seen light, a LED emitter and the like. The front pointer 415 and the top pointer 430 may be controlled using a user input unit, or by a controller of the sleeve's circuitry.

The pointers 415 and 430 may include at least one flashlight. The flashlight may be placed in the tip of the Sleeve, in such manner that the user of the sleeve can “point” the flashlight in various directions by moving his/her finger. The flashlight may be placed in the sleeve's sides. In a possible embodiment, the flashlight may be placed in the tip of the Sleeve.

While the user may hold the smart-phone vertically or in an alignment, the user may wish to be engaged in a video call. However, the user may be located in a dark environment, or in such conditions that are not optimal to clearly see his face. The user may hold his thumb, covered by the sleeve with the flashlight, perpendicular to the device, so his thumb will point towards his face. The smartphone's camera may then be in a better illumination conditions to improve visibility of the user's face.

In another possible embodiment, the user may hold the smartphone horizontally or in an angle when using it for navigation when walking. For example, a user may utilize a walking navigation application at night and may wish to keep the application open for turn-by-turn view and real-time monitoring of his movement. In such alignment, the smartphone's flashlight (usually located at the rear side of the device) will point towards the ground below the smartphone. By having additional illumination using the Sleeve, the user may point his finger (of the same hand) holding the smartphone further away, and get more area covered with light.

The sleeve may also comprise one or more sensors 420, 425. The one or more sensors 420, 425 may comprise a temperature sensor, a motion sensor, pressure sensor, proximity sensor, audio sensor, image sensor, and the like. The information collected by the one or more sensors 420, 425 may be stored in a memory of the sleeve's circuitry, or sent to a remote device using a communication module of the sleeve's circuitry, such as a transceiver, or sent over sleeve wire 450 as shown above.

The image sensor may be a camera. The Camera may be placed in the tip of the Sleeve, in such manner that the user wearing the sleeve can “point” the camera in various directions by moving the user's finger. The camera may be placed in the sleeve's sides. The camera can be a narrow-angle camera. In a possible embodiment, the camera may be placed in the tip of the sleeve. While the user may hold the smartphone horizontally or in an alignment, the user may wish to be engaged in a video call, while the phone is held away from the user. However, in most smart phones, the cameras are located at the upper side of the phone, thus when holding the phone in a manner which is not directed at the user, the relative position of the camera is not optimal. The sleeve's camera enables the user to hold his/her thumb perpendicular to the device, such as smartphone, so the thumb will point towards the user's face. The camera in the tip of the thumb may then be in a better position to improve coverage of the user's face.

In some other cases, the user may rotate his/her thumb towards other users in his vicinity that participate in the video call via his device. For example, a parent may have a video call with a grandparent, having his parents near him, and may intuitively point his thumb and/or forefingers towards each kid when they talk to improve coverage of their faces or rotate between then. In a possible embodiment, a smart-phone connected to the sleeve may enable the simultaneous operation of both the front smart-phone's camera, sleeve's cameras located in the sleeve portions covering the thumb and forefinger—i.e.—three cameras at the same time. A user may engage in a video call, having two other people sitting near him, and by pointing him thumb and forefinger one to each such person, the other persons can also participate in the video call and be seen, without the need to sit very close to the user holding the smartphone, so that the smart-phone's camera will cover all the persons. The sleeve's cameras may work in parallel to the smartphone's cameras. The smartphones may have means to synchronize and integrate parallel operation of both the smartphone's cameras and the sleeve's camera. The integration may result in a unified single video feed and/or photo. The integration may be in the form of different separate video feeds and/or photos.

The one or more sensors 420, 425 may comprise touch sensing means that monitor whether or not the Sleeve is in physical contact with the electronic device. The sensing means may include means to identify the type of electronic device—for example to identify that the electronic device is a smart phone and not a tablet. The sleeve may also comprise means to identify the model of the electronic device. The electronic device may include touch sensing means to identify that a sleeve is touching the electronic device, and the area in the electronic device that is touched. The means may also ne proximity sensing means. The means may enable a smart-phone to detect from which side the Sleeves are touching it. For example, a left-handed person will usually hold a smart-phone with his left hand, in such manner that the user's thumb will be on the left side of the device while his forefinger will emerge on the right side of the device—and vice-versa for right-handed people.

The sleeve may also comprise an antenna 440 enabling exchange of signals with other devices. The data received by the antenna may be stored in the sleeve's memory. The sleeve may also comprise sleeve wire 450 and sleeve connector 460 for charging the sleeve's circuitry or for exchanging information with another device without a wireless network.

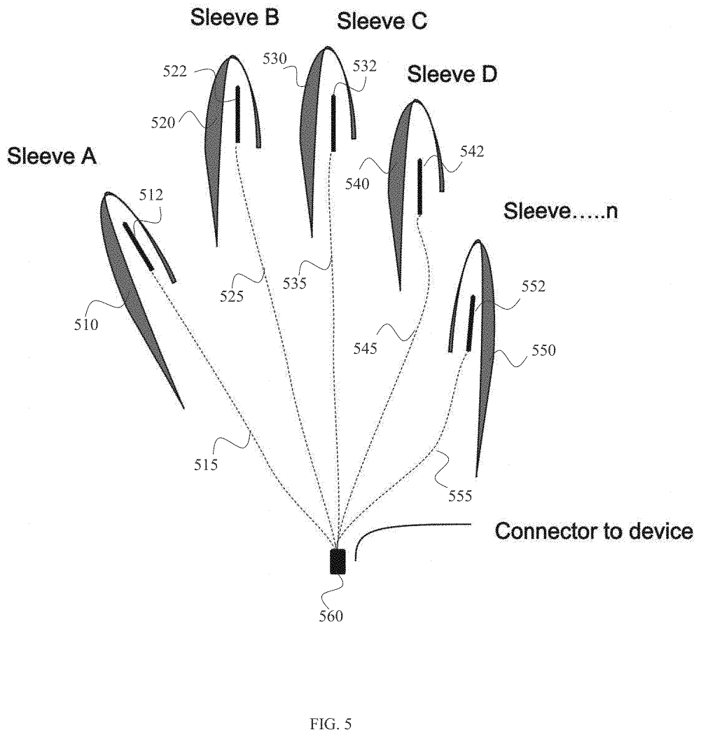

FIG. 5 schematically shows a sleeve having five sleeve portions covering all the palm's fingers, according to exemplary embodiments of the invention. Each of the sleeve portions is equipped with a sleeve portion circuitry and a sleeve wire coupled to sleeve connector 560. For example, sleeve portion 510 comprises sleeve portion circuitry 512 and sleeve wire 515, sleeve portion 520 comprises sleeve portion circuitry 522 and sleeve wire 525, sleeve portion 530 comprises sleeve portion circuitry 532 and sleeve wire 535, sleeve portion 540 comprises sleeve portion circuitry 542 and sleeve wire 545 and sleeve portion 550 comprises sleeve portion circuitry 552 and sleeve wire 555. In some cases, at least one of the sleeve portions may lack any circuitry or electrical components. In some cases, the components may vary between the various sleeve portions. For example, sleeve portion 510 may comprise sensors while sleeve portion 530 may comprise a front pointer.

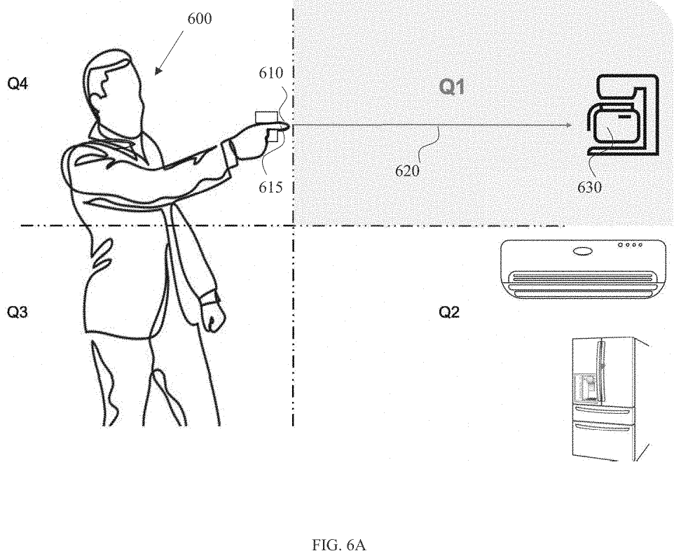

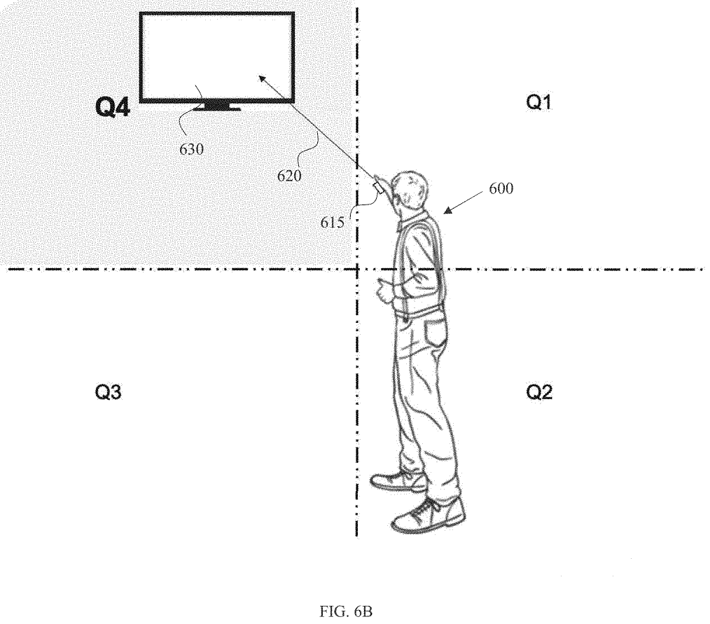

FIGS. 6A-6B schematically show a user directing a beam from a sleeve worn on the user's fingers to a remote device, according to exemplary embodiments of the invention. In FIG. 6A, the user 600 holds a sleeve 615 worn on the user's index finger. The sleeve 615 comprises a top pointer 610 directed towards the top end of the user's index finger. The top emitter 610 is configured to emit a beam 620, such as a laser beam, a light beam, a radio signal beam and the like. The user 600 directs the beam towards a remote electronic device 630, such as a cooking device, a kettle, a device capable of displaying information, an air conditioning device, and the like. The remote electronic device 630 may exchange information with another device in response to the beam 620 heating the remote electronic device 630. In some other cases, the remote electronic device 630 may change its mode of operation or properties of its operation (volume, display mode, activation, deactivation etc.) in response to the beam 620 heating the remote electronic device 630.

In FIG. 6B, the beam is directed at a certain area in the display device. The area may represent an input selected by the user 600, for example a selection from a menu displayed on the display. The user 600 may determine an operation mode of a device coupled to the display using the beam 620 emitted from the top pointer 610.

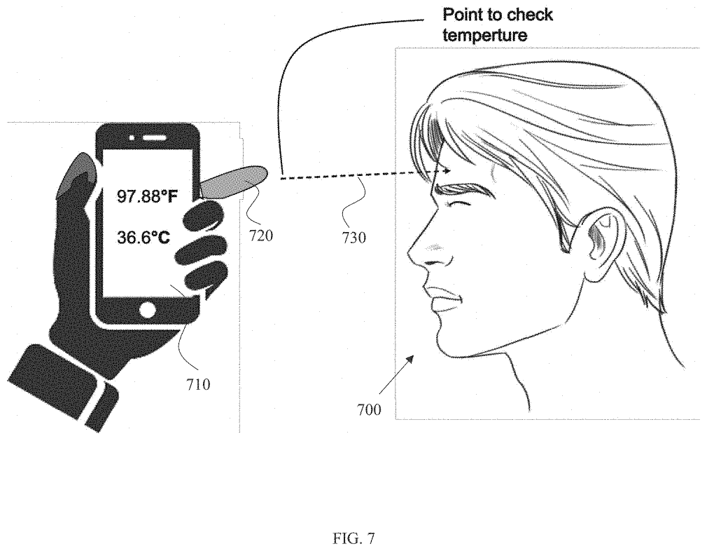

FIG. 7 schematically shows a user directing at another person's forehead to measure temperature, according to exemplary embodiments of the invention. The first user wears the sleeve 720 on the index finger while carrying a mobile electronic device 710, such as a mobile phone. The first user activates the sleeve 720 to emit a beam 730 towards a second user 700. The beam [HOW?] is used to measure the body temperature of the second user 700. The body temperature may then be displayed on a display of the mobile electronic device 710.

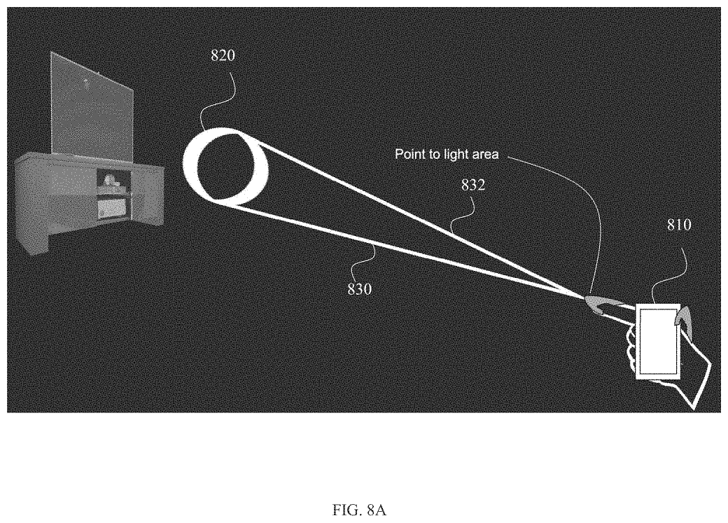

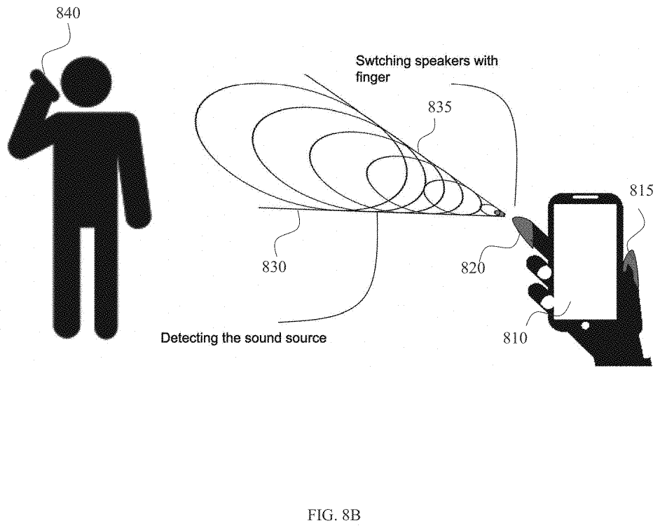

FIGS. 8A-8B schematically show two beams emitted from a pointer in a sleeve, according to exemplary embodiments of the invention. In FIG. 8A, the user holds mobile electronic device 810 with his/her palm, at least one finger of the user's palm is covered by the sleeve, using sleeve portions 815 and 820. The circuitry of sleeve portions 815 and 820 emits multiple beams 830, 835 from the emitter of the sleeve. In some cases, each beam of the multiple beams 830, 835 is emitted from a separate sleeve portion. In FIG. 8A, the beams 830, 835 are used to emit light towards an object, while in FIG. 8B, the beams are used to switch the sound emitted from one speaker to another speaker. The device at which the beams are directed is the device determined by the user of the sleeve to emit the audio signals.

While the disclosure has been described with reference to exemplary embodiments, it will be understood by those skilled in the art that various changes may be made, and equivalents may be substituted, for elements thereof without departing from the scope of the invention. In addition, many modifications may be made to adapt a particular situation or material to the teachings without departing from the essential scope thereof. Therefore, it is intended that the disclosed subject matter not limit the invention to any particular embodiment thereof.

What is claimed is:

1. A system, comprising:
an electronic device;
a sleeve configured to be worn on a person's finger, comprising:
a body, having a size matching a person's finger;
electrical circuitry coupled to the body, said circuitry comprising:
one or more sensors for collecting information;
a processing device for processing the collected information;
a transceiver for sending information to the electronic device.

2. The system of claim 1, wherein the electrical circuitry is covered by fabric.

3. The system of claim 1, wherein the one or more sensors comprise a motion sensor for collecting information concerning motion of the body.

4. The system of claim 1, wherein the one or more sensors comprise an environmental sensor for collecting information concerning an environment of the body.

5. The system of claim 1, wherein the one or more sensors comprise a touch sensor for sending whether or not the sleeve is in physical contact with the remote electronic device.

6. The system of claim 1, wherein the one or more sensors comprise a palm sensor configured to detect information enabling to determine whether the sleeve is worn by a right hand or a left hand of the person.

7. The system of claim 1, further comprising a light emitter directed away from the body and a light emitter input unit enabling a user of the sleeve to operate the light emitter.

8. The system of claim 7, wherein the wireless transceiver sends an azimuth of the light emitter to the remote electronic device.

9. The system of claim 7, wherein the body has an elongated shape having a tip, wherein the light emitter is located in the tip.

10. The system of claim 1, further comprising a camera directed away from the body and a camera input unit enabling a user of the sleeve to operate the camera.

11. The system of claim 11, wherein the wireless transceiver sends images captured by the camera and timestamps of the images to the remote electronic device.

12. The system of claim 1, further comprising a Direction Finding (DF) unit for finding a relative direction and/or the relative distance of signals emitted in the environment of the sleeve.

13. The system of claim 1, wherein the body comprises two sleeves for carrying two fingers, one finger in each sleeve of the two sleeves, wherein each sleeve of the two sleeves comprises at least one sensor.

14. The system of claim 1, wherein the body is made of fabric.

15. A method for creating a stream of images, comprising:
capturing a first set of images by a camera located in a sleeve worn on a person's finger;
sending the images and timestamp of the images to a remote electronic device;
capturing a second set of images by the remote electronic device when the first set of images are captured by the camera located in the sleeve;
creating a third set of images, wherein images in the third set of images are assembled from the first set of images and from the second set of images.

16. The method of claim 15, further comprising:
sending a direction of the camera located in the sleeve when capturing the images in the first set of images; and
creating the third set of images based on the direction of the camera located in the sleeve when capturing the images in the first set of images.
